(19) United States
(12) Patent Application Publication
(10) Pub. No.: US 2021/0371024 A1
(43) Pub. Date: Dec. 2, 2021

(54) Perimeter Beam Double Stretch Trailer

(71) Applicant: David W. Lutz, Carlisle, PA (US)

(72) Inventor: David W. Lutz, Carlisle, PA (US)

(21) Appl. No.: 17/332,130

(22) Filed: May 27, 2021

Related U.S. Application Data
(60) Provisional application No. 63/031,063, filed on May 28, 2020.

(51) Int. Cl. B62D 63/06; B62D 33/02; B62D 33/06; B62D 53/04

(52) U.S. Cl. CPC B62D 63/061; B62D 53/04; B62D 33/06; B62D 33/02

(57) ABSTRACT

A trailer having a bed portion includes: a deck including a first end and a second end and including a first side and a second side; a front extension moveably engaged with the first end of the deck, where the front extension includes a first beam moveably engaged with the deck on the first side and a second beam moveably engaged with the deck on the second side; and a rear extension moveably engaged with the second end of the deck, where the rear extension includes a first beam moveably engaged with the deck on the first side and a second beam moveably engaged with the deck on the second side. The first beam of the front extension is arranged vertically relative to the first beam of the rear extension, and the second beam of the front extension is arranged vertically relative to the second beam of the rear extension.

### CROSS REFERENCE TO RELATED APPLICATIONS

This application claims priority to U.S. Provisional Patent Application No. 63/031,063, filed May 28, 2020, the disclosure of which is hereby incorporated in its entirety by reference.

### BACKGROUND

### 1. Technical Field

The present invention relates to a trailer including a bed portion, the trailer being stretchable, e.g., extendable, in two directions.

### 2. Technical Considerations

Trailers, such as lowboy trailers, are attachable to cabs to haul loads of various shapes and sizes. At times, the load to be carried is quite long, and, thus, requires a trailer of significant length to haul the load. Other loads to be carried are quiet tall, requiring the platform on which the load is carried to be low to allow the load to safely travel under overpasses. Other loads to be carried are both quite long and quite tall.

### SUMMARY

The present invention is directed to a trailer having a bed portion including: a deck including a first end and a second end and including a first side and a second side; a front extension moveably engaged with the first end of the deck, where the front extension includes a first beam moveably engaged with the deck on the first side and a second beam moveably engaged with the deck on the second side; and a rear extension moveably engaged with the second end of the deck, where the rear extension includes a first beam moveably engaged with the deck on the first side and a second beam moveably engaged with the deck on the second side, where the first beam of the front extension is arranged vertically relative to the first beam of the rear extension, and the second beam of the front extension is arranged vertically relative to the second beam of the rear extension.

The first beam of the front extension may be arranged directly over or directly under the first beam of the rear extension, and the second beam of the front extension may be arranged directly over or directly under the second beam of the rear extension. The deck may include a platform between the first side and the second side, where the platform is arranged at a lower height compared to the first beams and/or the second beams of the front and rear extensions. The platform may be extendable to adjust a width between the first side and the second side. The platform may include a first section and a second section, where the first section includes a channel into which the second section is configured to moveably engage to adjust the width between the first side and the second side. The trailer may be a lowboy trailer. The front extension and/or the rear extension may be configured to be fastened at a predetermined length. The trailer may include an attachment portion configured to attach the trailer to a cab. The front extension may be moveable relative to the deck independent from the rear extension, and the rear extension may be moveable relative to the deck independent from the front extension. At least a portion of the bed portion may be made of steel. The trailer may include a plurality of axles and a bellcrank, where the bellcrank co-acts with the plurality of axles to turn the plurality of axles relative to the deck. Each of the plurality of axles may be attached to a turntable to effect turning of the plurality of axles. The bellcrank may be attached to a ring bearing and at least one cylinder, where rotation of the ring bearing effects movement of the at least one cylinder, which is configured to co-act with the turntables to effect turning of the plurality of axles. Each of the turntables may be attached to an adjacent turntable by an attaching member, such that rotation of one turntable effects rotation of the adjacent turntable. The trailer may include a plurality of axles, where the trailer further includes a power source configured to manually turn the plurality of axles.

The present invention is also directed to a towing system including: a cab; and a trailer having a bed portion including: a deck including a first end and a second end and including a first side and a second side; a front extension moveably engaged with the first end of the deck, where the front extension includes a first beam moveably engaged with the deck on the first side and a second beam moveably engaged with the deck on the second side; and a rear extension moveably engaged with the second end of the deck, where the rear extension includes a first beam moveably engaged with the deck on the first side and a second beam moveably engaged with the deck on the second side. The first beam of the front extension is arranged vertically relative to the first beam of the rear extension, and the second beam of the front extension is arranged vertically relative to the second beam of the rear extension.

The first beam of the front extension may be arranged directly over or directly under the first beam of the rear extension, and the second beam of the front extension may be arranged directly over or directly under the second beam of the rear extension. The deck may include a platform between the first side and the second side, where the platform is arranged at a lower height compared to the first beams and/or the second beams of the front and rear extensions. A load may rest on the platform. A height of the load may exceed a height that would travel under an overpass if placed over the first beams and/or the second beams of the front and rear extensions but may not exceed a height that would travel under an overpass if placed on the platform.

### BRIEF DESCRIPTION OF THE DRAWINGS

FIGS. 1A-1B show side views of a towing system with a trailer attached to a cab in the fully open (FIG. 1A) and fully closed (FIG. 1B) positions;

FIG. 2A shows a side view of a trailer in the open position;

FIG. 2B shows a cross-sectional view of A-A from FIG. 2A, the cross-sectional view showing the perimeter beam arrangement of the trailer;

FIG. 3A shows a side view of a trailer in the open position;

FIG. 3B shows a cross-sectional view of A-A from FIG. 3A, the cross-sectional view showing the perimeter beam arrangement of the trailer

FIG. 3C shows a close-up view of Section B from FIG. 3B, the close-up view showing the telescoping arrangement of the deck platform to adjust the width of the trailer;

FIG. 4 shows a perspective view of the trailer in an open position;

FIGS. 5A-5B show perspective views of a towing system with a trailer attached to a cab in the fully open (FIG. 5A) and fully closed (FIG. 5B) positions;

FIG. 6A shows a bottom view of a trailer having a bellcrank steering arrangement;

FIG. 6B shows a bottom perspective view of a trailer having a bellcrank steering arrangement; and

FIGS. 7A-7B show a ring bearing which co-acts with a bellcrank to steer the trailer, FIG. 7A showing the ring bearing in a straight position, and FIG. 7B showing the ring bearing in a turning position.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms.

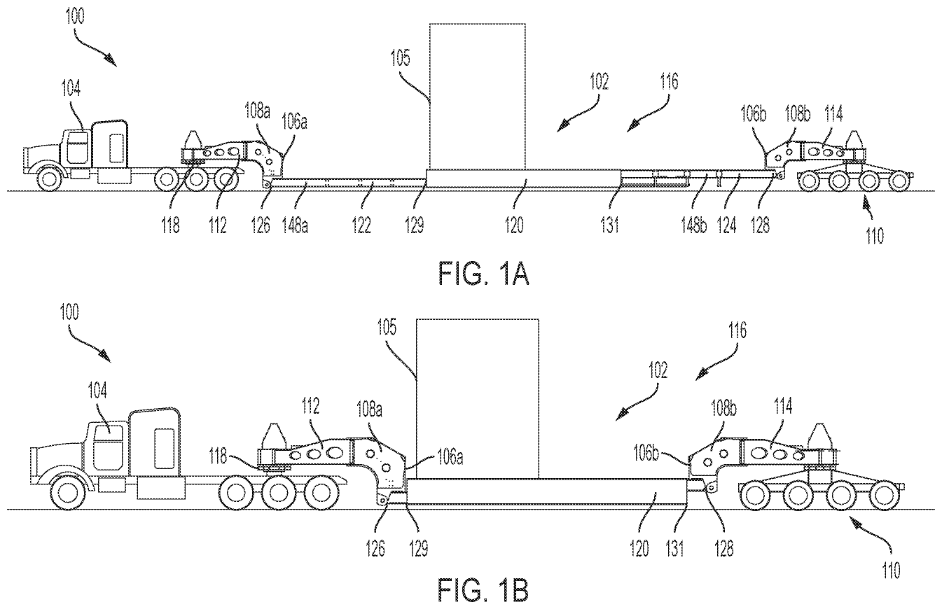

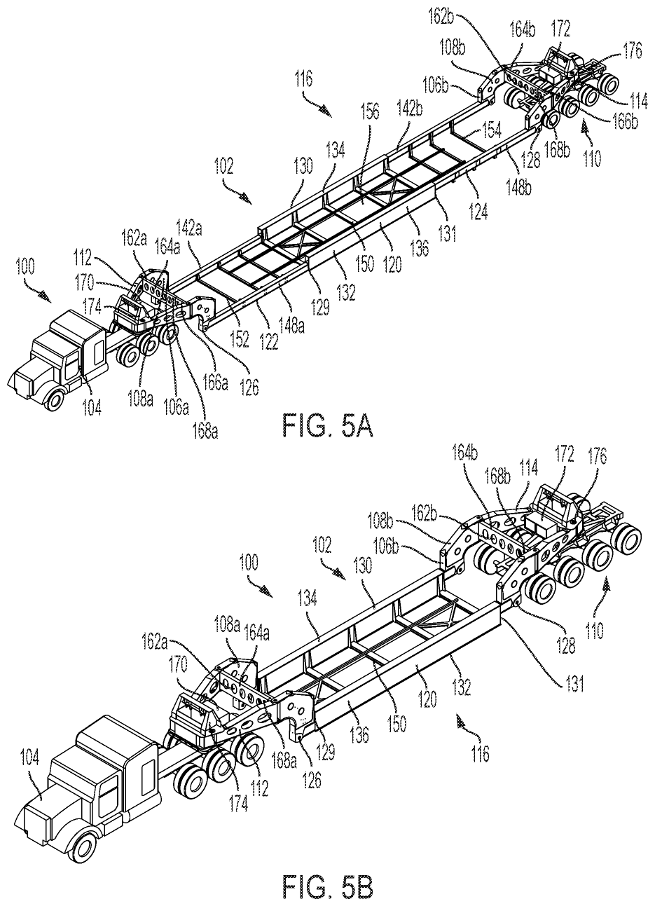

Referring to FIGS. 1A, 1B, 5A, and 5B, a towing system 100 may have a trailer 102 attached to a cab 104 to haul a load 105 of various shapes and sizes. The trailer 102 may be any type of trailer, such as a lowboy trailer (see FIGS. 1A-5B), a flatbed trailer, or a step deck trailer. A lowboy trailer may include two drops 106a, 106b in deck height: one right after the gooseneck 108a and one right before the rear wheels 110 of the trailer 102.

The cab 104 may be the cab of a truck or other motorized vehicle with sufficient power to tow the trailer 102. The trailer 102 may include an attachment portion 112, a rear portion 114, and a bed portion 116 running between the attachment portion 112 and the rear portion 114. The attachment portion 112 may engage with the cab 104 (such as with the fifth wheel 118 of the cab 104) to securely attach the trailer 102 to the cab 104. The attachment portion 112 may be fixed to or detachable from the bed portion 116. The trailer 102 may be attached to the cab 104 using any sufficient attaching configuration. The attachment portion 112 may be in contact with a first end 126 of the bed portion 116, and the rear portion 114 may be in contact with a second end 128 opposite the first end 126 of the bed portion 116. The rear portion 114 may include the rear wheels 110, and the rear wheels 110 may be steerable by a driver of the cab 104, when the trailer 102 is attached to the cab 104. The rear portion 114 may be fixed to or detachable from the bed portion 116.

With reference to FIGS. 1A-5B, the bed portion 116 may include a deck 120, a front extension 122, and a rear extension 124, the front extension 122 and the rear extension 124 moveably (e.g., slideably, rollably, etc.) engaged with the deck 120, such that the front extension 122 and the rear extension 124 may be movable relative to the deck 120. The deck 120 may have a larger thickness than the front extension 122 and rear extension 124 and may be able to support a higher stress (e.g., the deck 120 may be stronger than the front extension 122 and the rear extension 124). The deck 120 may have a first end 129 and a second end 131. The front extension 122 may be moveably engaged with the first end 129 to enable the trailer 102 to extend in the lengthwise direction by moving the front extension 122 toward or away from the first end 129 of the deck 120. The rear extension 124 may be moveably engaged with the second end 131 to enable the trailer 102 to extend in the lengthwise direction by moving the rear extension 124 toward or away from the second end 131 of the deck 120. The deck 120 may have a first side 130 and a second side 132, which sides 130, 132 may be defined by a first sleeve 134 and second sleeve 136, respectively. The first sleeve 134 may have a top receiving section 138 and a bottom receiving section 140 for receiving the first beams 142a, 142b of the front and rear extensions 122, 124 as described hereinafter (e.g., a telescoping arrangement). The second sleeve 136 may have a top receiving section 144 and a bottom receiving section 146 for receiving the second beams 148a, 148b of the front and rear extensions 122, 124 as described hereinafter (e.g., the telescoping arrangement).

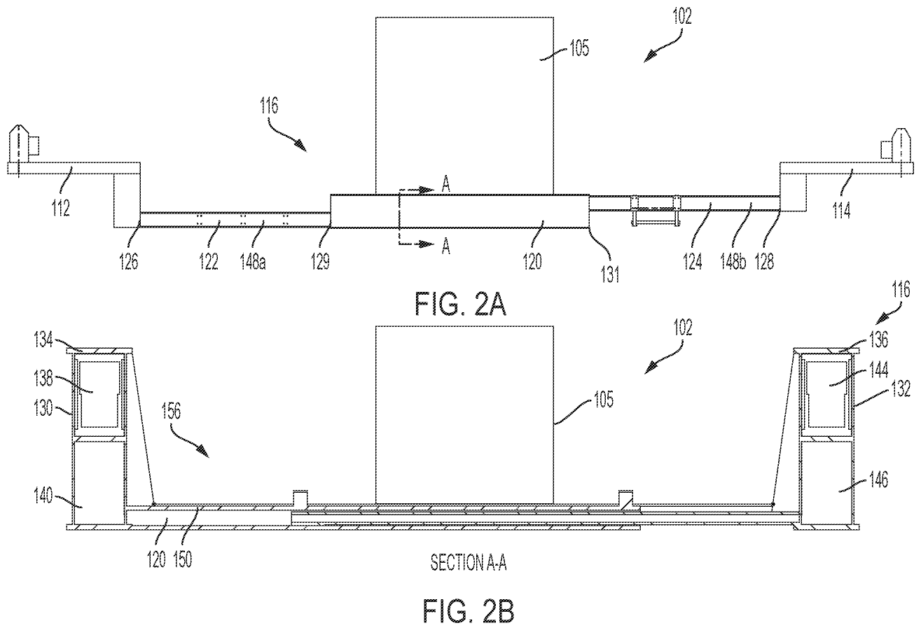

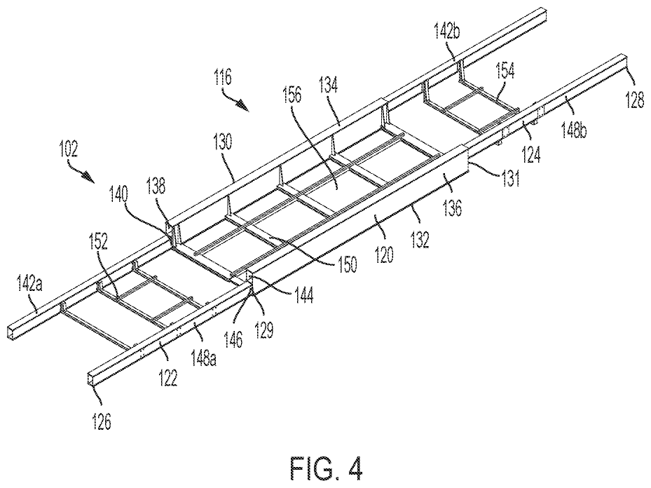

Referring to FIG. 4, the deck 120 may have a deck platform 150, the front extension 122 may include a plurality of beams (a first beam 142a and second beam 148a), and the front extension 122 may include a front platform 152 configured to carry a load 105 between the plurality of beams 142a, 148a. The rear extension 124 may include a plurality of beams (a first beam 142b and second beam 148b), and the rear extension 124 may include a rear platform 154 configured to carry a load 105 (see e.g., FIGS. 1A and 1B) between the plurality of beams 142b, 148b. The deck and/or front and/or rear platform 150, 152, 154 may be at a lower height than the top of the first and/or second beams 142a, 142b, 148a, 148b thereof. FIGS. 2A, 2B, and 4 show a non-limiting example of the deck and/or front and/or rear platform 150, 152, 154 being at a lower height than the top of the first and/or second beams 142a, 142b, 148a, 148b, with a cavity 156 for holding a load 105 being formed by the first and second beams 142a, 142b, 148a, 148b and the platform(s) 150, 152, 154 thereof.

Referring to FIGS. 1A-5B, the first beams 142a, 142b of the front and rear extensions 122, 124 may moveably engage the first sleeve 134 of the deck 120 (the first side 130 thereof) in a telescoping arrangement. The first beams 142a, 142b of the front and rear extensions 122, 124 may moveably engage the first sleeve 134 of the deck 120 to enable the trailer 102 to lengthen or shorten. The first beam 142a of the front extension 122 may be arranged vertically relative to the first beam 142b of the rear extension 124. The first beam 142a of the front extension 122 may be arranged directly over or directly under the first beam 142b of the rear extension 124. The first beam 142a, 142b being arranged “directly over or directly under” means that at least a portion of both first beams 142a, 142b overlap at least one same vertical plane. The top of one first beam 142a, 142b may be adjacent to the bottom of the other first beam 142a, 142b in the first sleeve 134. The first beam 142a of the front extension 122 may be over the first beam 142b of the rear extension 124, or the first beam 142b of the rear extension 124 may be over the first beam 142a of the front extension 122.

Referring to FIGS. 1A-5B, the second beams 148a, 148b of the front and rear extensions 122, 124 may moveably engage the second sleeve 136 of the deck 120 (the second side 132 thereof) in a telescoping arrangement. The second beams 148a, 148b of the front and rear extensions 122, 124 may moveably engage the second sleeve 136 of the deck 120 to enable the trailer 102 to lengthen or shorten. The second beam 148a of the front extension 122 may be arranged vertically relative to the second beam 148b of the rear extension 124. The second beam 148a of the front extension 122 may be arranged directly over or directly under the second beam 148b of the rear extension 124. The second beam 148a, 148b being arranged “directly over or directly under” means that at least a portion of both second beams 148a, 148b overlap at least one same vertical plane. The top of one second beam 148a, 148b may be adjacent to the bottom of the other second beam 148a, 148b in the second sleeve 136. The second beam 148a of the front extension 122 may be over the second beam 148b of the rear extension 124, or the second beam 148b of the rear extension 124 may be over the second beam 148a of the front extension 122.

Referring to FIGS. 1A-1B and 5A-5B, the front extension 122 and rear extension 124 may moveably engage the deck 120 to lengthen or shorten the trailer 102. FIGS. 1B and 5B show the trailer 102 in the fully closed position with both the front extension 122 and rear extension 124 fully inserted into the deck 120. FIGS. 1A and 5A show the trailer 102 in the fully open position with both the front extension 122 and rear extension 124 fully extended away from the deck 120 in the lengthwise direction. In this fully extended position, at least a portion of the first beams 142a, 142b and/or the second beams 148a, 148b may remain within the first or second sleeve 134, 136 respectively, but may not be further extended lengthwise from the deck 120. Thus, in the fully open position, the length of the trailer 102 may be at least the length of the deck 120 plus the length of the exposed section of the front extension 122 plus the length of the exposed section of the rear extension 124. The overlap in the beams 142a, 142b, 148a, 148b and the sleeves 134, 136 even in the fully open position may provide additional strength to the trailer 102. Partially opened/partially closed positions may be arranged as well with at least one of the front extension 122 and rear extension 124 at least partially extended lengthwise away from the deck 120. For example, the front extension 122 or the rear extension 124 may be extended lengthwise away from the deck 120 while the other is fully inserted into the deck 120. The front extension 122 and/or the rear extension 124 may be fastened at a predetermined length (e.g., the fully extended length, the fully closed length, or some length therebetween) to obtain the desired trailer length. The front extension 122 may be movable relative to the deck 120 independent from the rear extension 124, and the rear extension 124 may be moveable relative to the deck 120 independent from the front extension 122.

Referring again to FIGS. 1A-5B, the front extension 122 and/or the rear extension 124 may be moved relative to the deck 120 using any suitable method. For instance, the front extension 122 and/or the rear extension 124 may be moved to extend away from the deck 120 or into the deck 120 manually. The front extension 122 and/or the rear extension 124 may be moved using the cab 104. For example, the trailer 102 may be attached to the cab 104. To move the front extension 122 away from the deck 120, a pin (or other fastening mechanism) co-acting with the front extension 122 may be moved from the locked position to the unlocked position. The cab 104 may then drive forward to extend the front extension 122 away from the deck 120. The cab 104 may be driven in reverse to move the front extension 122 back into the deck 120. To move the rear extension 124 away from the deck 120, the pin (or other fastening mechanism) co-acting with the rear extension 124 may be moved from the locked position to the unlocked position. The cab 104 may then drive forward to extend the rear extension 124 away from the deck 120. The cab 104 may be driven in reverse to move the rear extension 124 back into the deck 120. The front extension 122 and the rear extension 124 may be moved in the above-described manner (using the cab 104) simultaneously by placing the pins (or other fastening mechanism) co-acting with the front and rear extensions 122, 124 in the unlocked position.

The first beams 142a, 142b engaging with the first sleeve 134 may each have a length at least half the length of the deck 120, and may have a length that is the same as the length of the deck 120. Although both first beams 142a, 142b are moveably engaged with the first side 130 of the deck 120 (e.g., the first sleeve 134) they can be longer than half the length of the deck 120 without running into the other first beam 142a, 142b due to the vertical arrangement of the first beams 142a, 142b relative to one another. This allows for additional strengthening to the trailer 102, as well as the ability to stretch longer compared to a trailer 102 with first beams 142a, 142b only half of less of the length of the deck 120.

The second beams 148a, 148b engaging with the second sleeve 136 may each have a length at least half the length of the deck 120, and may have a length that is the same as the length of the deck 120. Although both second beams 148a, 148b are moveably engaged with the second side 132 of the deck 120 (e.g., the second sleeve 136) they can be longer than half the length of the deck 120 without running into the other second beam 148a, 148b due to the vertical arrangement of the second beams 148a, 148b relative to one another. This allows for additional strengthening to the trailer 102, as well as the ability to stretch longer compared to a trailer 102 with second beams 148a, 148b only half of less of the length of the deck 120.

The first and second beams 142a, 142b, 148a, 148b of the front and rear extensions 122, 124 moveably engaging the deck 120 at the sides (the first and second sleeves 134, 136 defining the sides 130, 132) as shown in FIGS. 1A-5B may be referred to as a trailer 102 having a perimeter beam arrangement, as the beams 142a, 142b, 148a, 148b of the front and rear extensions 122, 124 engage the side perimeter of the deck 120.

The perimeter beam arrangement may enable the deck platform 150 of the deck 120 between the first and second sides thereof to be arranged at a lower height compared to the first beams 142a, 142b and/or the second beams 148a, 148b of the front and rear extensions 122, 124. For example a level of the deck platform 150 may be lower than a top level of the upper beams or the upper surface of the sleeves 134, 136. As shown in FIG. 2B, the first and second sleeves 134, 136 into which the beams 142a, 142b, 148a, 148b are moveably engaged and the deck platform 150 may form the cavity 156 in the deck 120, and the load 105 may be arranged into the cavity 156 (resting on the deck platform 150 thereof). This arrangement enables the load 105 to be supported by the beams 142a, 142b, 148a, 148b, while allowing the deck platform 150 to carry a taller load 105 due to the fact that the load 105 is arranged in the cavity 156 at a lower level of at least one of the beams 142a, 142b, 148a, 148b.

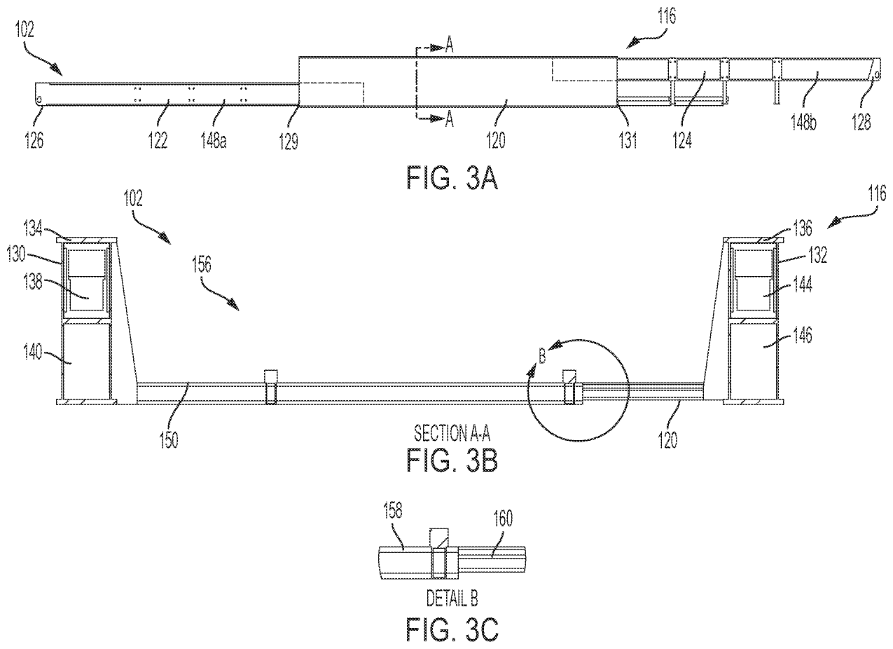

Referring to FIGS. 3B and 3C, the deck platform 150 of the deck 120 between the first and second sides 130, 132 may be extendable to adjust a width between the first and second sides 130, 132 (the width of the trailer 102). The deck platform 150 may be extendable according to any arrangement. For example, as shown in FIG. 3C, the deck platform 150 may include a first section 158 and a second section 160, wherein the first section 158 comprises a channel into which the second section 160 is configured to moveably (e.g., slideably, rollably, etc.) engage to adjust the width of the deck platform 150 between the first side 130 and the second side 132, such as using the shown telescoping arrangement. The second section 160 may be fastened (e.g., pinned) relative to the first section 158 at the desired trailer width.

Referring to FIGS. 5A and 5B, the attachment portion 112 and/or the rear portion 114 may include at least one gooseneck 108a, 108b. The gooseneck 108a of the attachment portion 112 may attach to the front extension 122, and the gooseneck 108b of the rear portion 114 may attach to the rear extension 124 (e.g., the first and second beams 142a, 142b, 148a, 148b thereof). The goosenecks 108a, 108b may be adjustable to adjust the width of the trailer 102, and the goosenecks 108a, 108b may be adjustable using any suitable configuration. In one non-limiting example shown in FIGS. 5A-5B, the goosenecks 108a, 108b may include an adjustable bar 162a, 162b having a first section 164a, 164b comprising a channel into which a second section 166a, 166b is configured to moveably (e.g., slideably, rollably, etc.) engage to widen and narrow to adjust the width of the gooseneck, and thus the width of the trailer 102 (between the first and second sides 130, 132). The adjustable bar 162a, 162b may be fastened (e.g., pinned) by fasteners 168a, 168b at the desired width.

With continued reference to FIGS. 5A and 5B, the trailer 102 may include at least one power source 170, 172, which power source 170, 172 may power certain electrical features of the trailer 102, such as power steering, a lift box 174, 176 (described hereinafter), gooseneck adjustment, and/or the like. The trailer 102 may include a single power source to power the components of the trailer 102. As shown in FIGS. 5A-5B, the trailer 102 may include a plurality of power sources 170, 172 to power the components of the trailer 102, such as a first power source 170 as a power unit mounted on the attachment portion 112 to power the components on the front portion of the trailer 102 and a second power source 172 as a power unit mounted on the rear portion 114 to power the components on the rear portion 114 of the trailer 102. The power source may include a hydraulic power source.

With continued reference to FIGS. 5A and 5B, the trailer 102 may include at least one lift box 174, 176, which may raise at least a portion of the trailer 102 further off the ground. The lift box 174, 176 may enable the trailer 102 to drive over humps and other road obstacles by raising the height of the trailer 102 thereover. The lift box 174, 176 may raise the level of the goosenecks and/or the bed portion 116 to avoid such obstacles. A single lift box may be used to raise the entire trailer 102. As shown in FIGS. 5A-5B, a front lift box 174 and a rear lift box 176 may be used on the trailer 102 together to lift the attachment and rear portions 112, 114 of the trailer 102 over the raised obstacles. The power source(s) 170, 172 may power the lift boxes 174, 176 to raise or lower the level of the trailer 102. The power source 170, 172 may comprise the engine of the cab 104, such that power is taken off therefrom and used to power the components of the trailer 102. The power source 170, 172 may comprise the power unit(s) mounted on the trailer 102, such as a direct current, gas, diesel, and the like power unit.

The trailer 102, in particular the bed portion 116 of the trailer 102, may be made of any material of suitable strength, such as metal. At least a portion of the bed portion 116 may be made of steel. At least a portion of the deck 120 may be made of steel. At least a portion of the front extension 122 and/or the rear extension 124 may be made of steel, such as a portion of the first and second beams 142a, 142b, 148a, 148b.

The trailer 102 may carry a load 105. The load 105 may rest on the deck platform 150 of the deck 120. The load 105 may also rest on the front platform 152 and/or the rear platform 154 with the front extension 122 and/or the rear extension 124 extended away from the deck 120. The load 105 may be a long load 105 which is longer than the length of just the deck 120, such that it rests on the deck 120 and at least a portion of the front extension 122 and/or the rear extension 124.

The load 105 may be a tall load such that the height of the load 105 if resting on the first or second beams 142a, 142b, 148a, 148b (and the sleeves 134, 136 of the deck 120) would exceed a height capable of passing under an overpass, but does not exceed a height that would travel under an overpass if placed on the deck platform 150. As such, the lower level of the deck platform 150 allows such tall loads 105 to be carried under overpasses. The overpasses may include bridges, tunnels, road signs, stoplights, overhead wires, and/or the like. The overpasses may be up to 20 feet over the road, such as up to 19 feet, up to 18 feet, up to 17 feet, up to 16 feet, up to 15 feet, up to 14 feet, up to 13 feet, up to 12 feet, up to 11 feet, or up to 10 feet over the road. The load 105 being carried may be both a long and a tall load. The load 105 may be, for example, a subway car or railway car boxes, tanks for holding liquid/gas, or any other cumbersome load that is long and/or tall.

In the non-limiting example of the load 105 being a subway car or railway car boxes, the deck and/or front and/or rear platform 150, 152, 154 may comprise rails (see e.g., FIGS. 2B, 3B, 3C, 4, 5A, and 5B) on which the subway car or railway car boxes may rest during transportation on the trailer 102. However, it will be appreciated that the rails on the deck and/or front and/or rear platform 150, 152, 154 are optional and may not be included for other types of loads being transported by the trailer 102.

The perimeter beam trailer 102 may be steerable in a manual mode and/or an automatic mode as described hereinafter.

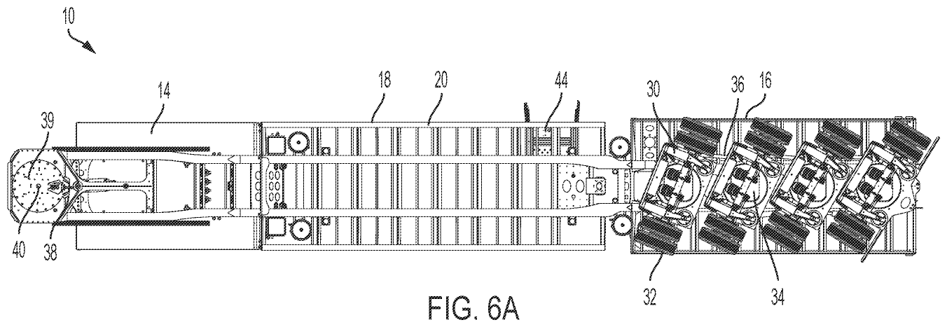

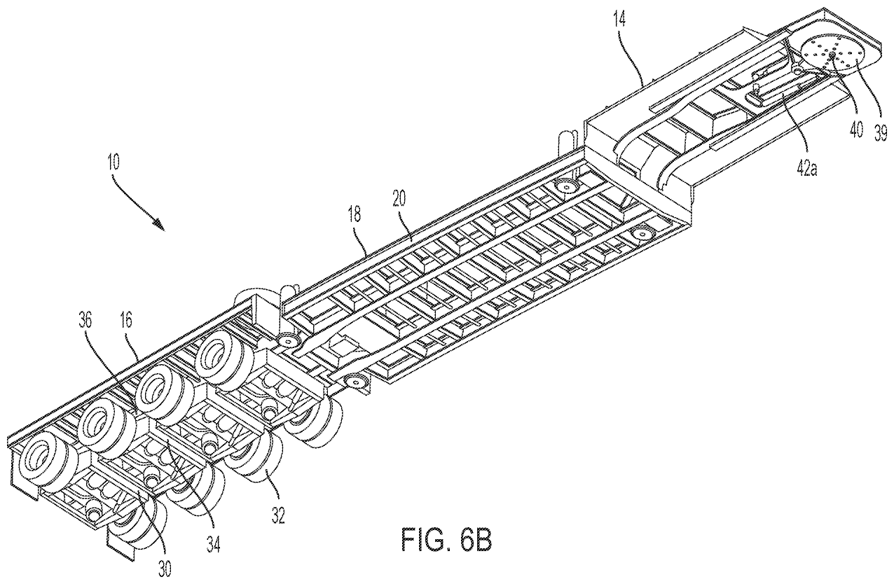

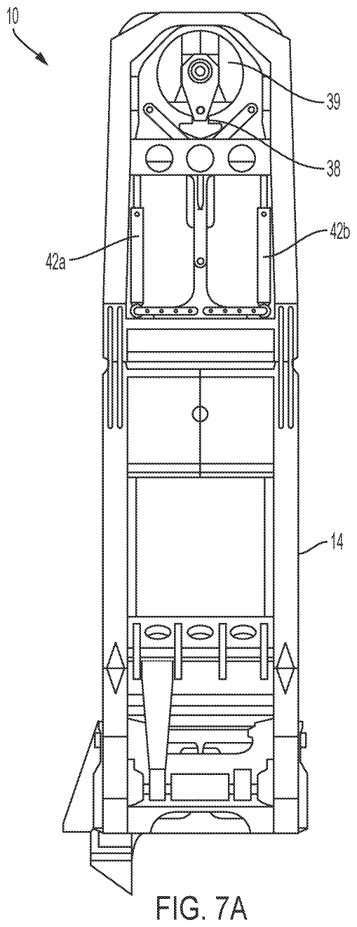

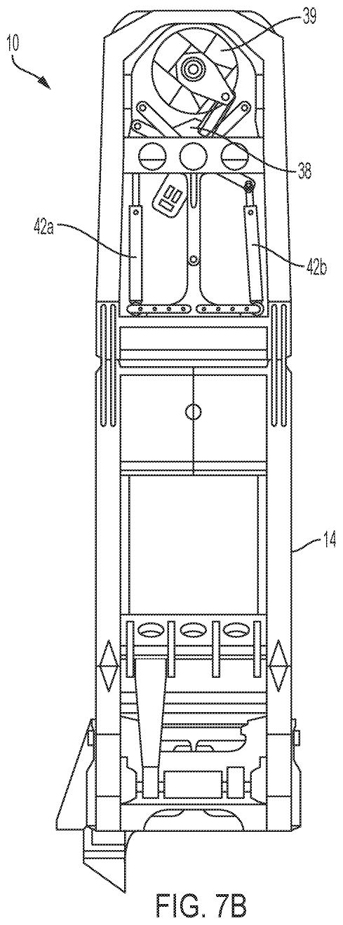

Referring to FIGS. 6A-7B, a non-limiting embodiment of a trailer 10 (e.g., the perimeter beam trailer 102 as previously described) having a steering mechanism for steering the trailer 10 in an automatic steering mode is shown. The trailer 10 may include a plurality of axles 30, each axle 30 attached to wheels 32. The wheels 32 may roll along the ground upon rotation of the axles 30 so that the trailer 10 can move. The axles 30 may each be attached to a turntable 34, which is attached to the trailer 10. For instance, the turntables 34 may be attached to a rear portion 16 (e.g., the previously described rear portion 114) and/or an attachment portion 14 (e.g., the previously described attachment portion 112) of the trailer 10. The turntables 34 may be rotatably attached to the trailer 10, such that rotation of the turntables 34 turns the axles 30 (and therefore the wheels 32) relative to the trailer 10. Each turntable 34 may be attached to an adjacent turntable 34 via an attaching member 36. In some non-limiting embodiments, the attaching member 36 may be a cylinder or a rod; however, the attaching member 36 may be any other suitable member. The adjacent turntables 34 may be attached by the attaching member 36 so that rotation of one of the turntables 34 may effect rotation of the adjacent turntables 34. While turntable axles are described herein, it will be appreciated that kingpin axles could also be used for steering the trailer 10.

With continued reference to FIGS. 6A-7B, the wheels 32 (such as the wheels 32 of the rear portion 16 as in FIGS. 6A-6B and/ the previously-described rear wheels 110) may be steered using a bellcrank 38 arrangement. The bellcrank 38 may be positioned in the attachment portion 14 of the trailer 10. The bellcrank 38 may co-act with the plurality of axles 30 to turn the plurality of axles 30 (and therefore the wheels 32) relative to the deck 20 (e.g. the previously-described deck 120). The bellcrank 38 may include a ring bearing 39 rotatable relative to the attachment portion 14. The ring bearing 39 may be circular. The ring bearing may include a pin 40 to attach the trailer 10 to a cab (not shown; e.g., the previously-described cab 104) such that the cab may tow the trailer 10. The bellcrank 38 may also include at least one cylinder 42a, 42b. To steer the trailer 10, rotation of the ring bearing 39 may cause movement of the at least one cylinder 42a, 42b, the motion transferred through the bellcrank 38. Movement of the at least one cylinder 42a, 42b may co-act with the turntables 34 to effect turning of the axles 30. The at least one cylinder 42a, 42b may co-act with at least one rear cylinder (not shown) proximate the wheels 32 of the rear portion 16. The at least one cylinder 42a, 42b may be attached to the at least one rear cylinder by hydraulic lines (not shown). The at least one cylinder 42a, 42b may cause the movement (through the hydraulic lines) of the at least one rear cylinder by the same amount. For example, movement of the cylinder 42a, 42b by one inch many cause movement of the rear cylinder by one inch. Therefore, according to the steering arrangement, the cab may turn to exert a force on the pin 40 attached thereto. The pin 40 may cause rotation of the ring bearing 39, the motion of which is transferred to the at least one cylinder 42a, 42b through the bellcrank 38. The movement of the at least one cylinder 42a, 42b causes movement of the at least one rear cylinder to effect rotation of the turntables 34 to turn the axles 30. The axles 30 may not turn by the same amount (degrees relative to the attachment portion 14) as the amount the ring bearing 39 is rotated. The axles 30 may be restricted so that they may only turn a certain number of degrees.

Referring to FIGS. 7A-7B, in some non-limiting embodiments, the attachment portion 14 may include two cylinders 42a, 42b. In FIG. 7A the ring bearing 39 is not rotated relative to the attachment portion 14 (a straight position). Meanwhile, in FIG. 7B, the ring bearing 39 is rotated relative to the attachment portion 14, which (through the bellcrank 38) causes movement of the two cylinders 42a, 42b (a turning position). In this example, the ring bearing 39 rotates counterclockwise (from a left turn of an attached cab), pushing the right cylinder 42b and pulling the left cylinder 42a. Not shown in this FIG. 7B is the movement of the cylinders 42a, 42b causing movement of corresponding cylinders in the rear portion 16 of the trailer 10, which effects turning of the axles 30.

With continued reference to FIGS. 6A-7B, the bellcrank 38 arrangement may be used in the automatic steering mode, as described above, to steer the wheels 32 based on the direction of the cab to which the trailer 10 is attached is moving. A turn by the cab in this automatic steering mode may exert a force on the pin 40 of the bellcrank 38. The bellcrank 38 may co-act with the pin 40 and, in turn, exert a force on the cylinders 42a, 42b. The cylinders 42a, 42b may then co-act with the turntables 34 to rotate the turntables 34, which turns the axles 30. Thus, turning of the cab effects turning of the wheels 32. FIG. 6A shows a non-limiting embodiment of the axles 30 turned. Each of the axles 30 may be turned at the same or different angle relative to the deck 20.

With continued reference to FIGS. 6A-7B and also referring to FIGS. 1A, 1B, 5A, and 5B, the automatic bellcrank 38 arrangement (e.g., including the ring bearing 39 and at least one cylinder 42a, 42b) may be arranged at the attachment portion 112 and/or the rear portion 114 of the trailers 102 shown in FIGS. 1A, 1B, 5A, and 5B. For example, the bellcrank arrangement 38 including the ring bearing 39 and the at least one cylinder 42a, 42b may be arranged at the attachment portion 112 such that movement (e.g., turning) of the trailer 102 in the region of the attachment portion 112 causes automatic steering of at least some of the wheels of the trailer 102 (e.g., the rear wheels 110). For example, the bellcrank arrangement 38 including the ring bearing 39 and the at least one cylinder 42a, 42b may be arranged at the rear portion 114 such that movement (e.g., turning) of the trailer 102 in the region of the rear portion 114 causes automatic steering of at least some of the wheels of the trailer 102 (e.g., the rear wheels 110).

With continued reference to FIGS. 6A-7B, the trailer 10 may be steered in the automatic steering mode without including a bellcrank 38 arrangement. Instead, the bellcrank 38 may be replaced with an electronic encoder sensor which communicates with a power source 44 and activates an automatic rear steering mechanism.

With continued reference to FIGS. 6A-7B, the trailer 10 may be configured to be steered in a manual mode. The trailer 10 may include at least one power source 44 (e.g., the same or different power source(s) 170, 172 previously described). The power source 44 may be configured to allow a driver of the cab towing the trailer 10 to manually turn the axles 30. The axles 30 may turn while the trailer 10 is stationary. The power source 44 may allow for each axle 30 to be turned manually (relative to the deck 20) and may allow for a single axle 30 or any combination of axles 30 to be turned manually. This may allow for more precise control over the turning of the trailer 10, which may be useful for particularly tight or otherwise difficult turns. In some non-limiting embodiments, the power source 44 may turn the axle(s) 30 manually when the trailer 10 is stationary (before beginning movement). This may allow the trailer 10 to begin a turn immediately when starting movement from a stationary position.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent ranges that are within the spirit and scope of the appended claims. For example, it is to be understood that the present invention contemplates, to the extent possible, one or more features of any embodiment can be combined with one or more features of any other embodiment.

The invention claimed is

1. A trailer comprising a bed portion comprising:
a deck comprising a first end and a second end and comprising a first side and a second side;
a front extension moveably engaged with the first end of the deck, wherein the front extension comprises a first beam moveably engaged with the deck on the first side and a second beam moveably engaged with the deck on the second side; and
a rear extension moveably engaged with the second end of the deck, wherein the rear extension comprises a first beam moveably engaged with the deck on the first side and a second beam moveably engaged with the deck on the second side,
wherein the first beam of the front extension is arranged vertically relative to the first beam of the rear extension, and the second beam of the front extension is arranged vertically relative to the second beam of the rear extension.

2. The trailer of claim 1, wherein the first beam of the front extension is arranged directly over or directly under the first beam of the rear extension, and the second beam of the front extension is arranged directly over or directly under the second beam of the rear extension.

3. The trailer of claim 1, wherein the deck comprises a platform between the first side and the second side, wherein the platform is arranged at a lower height compared to the first beams and/or the second beams of the front and rear extensions.

4. The trailer of claim 3, wherein the platform is extendable to adjust a width between the first side and the second side.

5. The trailer of claim 4, wherein the platform comprises a first section and a second section, wherein the first section comprises a channel into which the second section is configured to moveably engage to adjust the width between the first side and the second side.

6. The trailer of claim 1, wherein the trailer comprises a lowboy trailer.

7. The trailer of claim 1, wherein the front extension and/or the rear extension are configured to be fastened at a predetermined length.

8. The trailer of claim 1, wherein the trailer comprises an attachment portion configured to attach the trailer to a cab.

9. The trailer of claim 1, wherein the front extension is movable relative to the deck independent from the rear extension, and the rear extension is movable relative to the deck independent from the front extension.

10. The trailer of claim 1, wherein at least a portion of the bed portion is made of steel.

11. The trailer of claim 1, wherein the trailer comprises a plurality of axles and a bellcrank, wherein the bellcrank co-acts with the plurality of axles to turn the plurality of axles relative to the deck.

12. The trailer of claim 11, wherein each of the plurality of axles is attached to a turntable to effect turning of the plurality of axles.

13. The trailer of claim 12, wherein the bellcrank is attached to a ring bearing and at least one cylinder, wherein rotation of the ring bearing effects movement of the at least one cylinder, which is configured to co-act with the turntables to effect turning of the plurality of axles.

14. The trailer of claim 12, wherein each of the turntables is attached to an adjacent turntable by an attaching member, such that rotation of one turntable effects rotation of the adjacent turntable.

15. The trailer of claim 1, wherein the trailer comprises a plurality of axles, wherein the trailer further comprises a power source configured to manually turn the plurality of axles.

16. A towing system, comprising:
a cab; and
a trailer comprising a bed portion comprising:
a deck comprising a first end and a second end and comprising a first side and a second side;
a front extension moveably engaged with the first end of the deck, wherein the front extension comprises a first beam moveably engaged with the deck on the first side and a second beam moveably engaged with the deck on the second side; and
a rear extension moveably engaged with the second end of the deck, wherein the rear extension comprises a first beam moveably engaged with the deck on the first side and a second beam moveably engaged with the deck on the second side,
wherein the first beam of the front extension is arranged vertically relative to the first beam of the rear extension, and the second beam of the front extension is arranged vertically relative to the second beam of the rear extension.

17. The towing system of claim 16, wherein the first beam of the front extension is arranged directly over or directly under the first beam of the rear extension, and the second beam of the front extension is arranged directly over or directly under the second beam of the rear extension.

18. The towing system of claim 16, wherein the deck comprises a platform between the first side and the second side, wherein the platform is arranged at a lower height compared to the first beams and/or the second beams of the front and rear extensions.

19. The towing system of claim 18, wherein a load rests on the platform.

20. The towing system of claim 19, wherein a height of the load exceeds a height that would travel under an overpass if placed over the first beams and/or the second beams of the front and rear extensions but does not exceed a height that would travel under an overpass if placed on the platform.
